(19) United States
(12) Patent Application Publication
(10) Pub. No.: US 2020/0042851 A1
(43) Pub. Date: Feb. 6, 2020

(54) SYSTEM AND METHOD FOR CONTROLLING ACCESS TO CONTENT OF CONTAINERS

(71) Applicant: VERIFIED PLANET LTD., Petach Tikva (IL)

(72) Inventor: Chen SARFATI HALABI, Petach Tikva (IL)

(73) Assignee: VERIFIED PLANET LTD., Petach Tikva (IL)

(21) Appl. No.: 16/476,299

(22) PCT Filed: Jan. 16, 2018
(86) PCT No.: PCT/IL2018/050056

§ 371 Date: Jul. 8, 2019

Related U.S. Application Data
(60) Provisional application No. 62/446,547, filed on Jan. 16, 2017.

(51) Int. Cl. G06K 19/07; B01L 3/00

(52) U.S. Cl. CPC G06K 19/0723; B01L 3/508; B01L 3/5457

(57) ABSTRACT

System and methods for controlling access to content of at least one container, wherein the system is remotely connected to an external server, the system including: a lock unit, configured to lock a container and prevent access to the content therein, a unique readable tag, attachable to the container, and a key unit, wherein the key unit includes: a processor, connectable to the server via a communication channel, a detector, coupled to the processor, and adapted to read readable tags, and a key, coupled to the detector, and adapted to unlock the lock unit upon receipt, by the processor, of tag identification from the detector and also receipt of access authorization data, wherein the access authorization data is provided by the server upon confirmation of the tag identification data.

### FIELD OF THE INVENTION

The present invention generally relates to locking of containers. More particularly, the present invention relates to systems and methods for controlling access to content of containers.

### BACKGROUND OF THE INVENTION

Different types of containers are used to store various items, such as food, medicine or even human tissue (e.g., in a Petri dish). While these containers are capable of storing the required items, there is little or no control or tracking of access to the content of such containers.

This is particularly a problem for containers holding human tissue (e.g., with in vitro fertilization), where the owner of the deposited tissue has no control over the use thereof For example, a lab working with sensitive materials (such as blood samples or viruses) cannot provide any security measures for the material stored in containers since any staff member has access to the containers, and there is no real control over opening of such containers. Moreover, mistakes may occur as any container can be opened at any time without verification that it is the correct container and/or that this particular container is to be opened at all.

### SUMMARY OF THE INVENTION

There is thus provided, in accordance with some embodiments of the invention, a system for controlling access to content of at least one container, wherein the system is remotely connected to an external server, including: a lock unit, configured to lock a container and prevent access to the content therein, a unique readable tag, attachable to the container, and a key unit, wherein the key unit includes: a processor, connectable to the server via a communication channel, a detector, coupled to the processor, and adapted to read readable tags, and a key, coupled to the detector, and adapted to unlock the lock unit upon receipt, by the processor, of tag identification from the detector and also receipt of access authorization data. In some embodiments, the access authorization data may be provided by the server upon confirmation of the tag identification data.

In some embodiments, the key unit may include a user interface unit to receive from the server the access authorization data for a locked container identified by the detector. In some embodiments, the system may include a memory unit, coupled to the processor, to store data that is indicative to each locked container, wherein the stored data includes information for at least one of content within the container, owner of the content within the container, and authorized users to open the container.

In some embodiments, the unique readable tag may include radio-frequency identification (RFID). In some embodiments, each unique readable tag may include access authorization data corresponding to owner of the content in the respective container. In some embodiments, each unique readable tag may include access authorization data corresponding to the content in the respective container.

In some embodiments, the detector may be further configured to perform user identification. In some embodiments, the system may include a database, coupled to the server, the database including a list with authorized containers to be opened. In some embodiments, the key may be further configured to lock the container.

In some embodiments, the system may include a locking segment configured to be assembled onto the container and also configured to be coupled to the lock unit. In some embodiments, the locking segment may include a wrapping portion configured to be wrapped around the container.

There is thus provided, in accordance with some embodiments of the invention, a method of controlling access to content of at least one container, including: locking at least one container, with a lock unit, to prevent access to the content therein, receiving from a detector reading of at least one unique readable tag, for at least one locked container, receiving an identification of a user, verifying authorization of user to access content, and changing a state of the lock unit from a locked state to an unlocked state, with a key coupled to the detector, when a confirmation is received.

In some embodiments, a unique readable tag may be attached to each of the at least one locked container. In some embodiments, tag identification may be compared to a database of authorized containers to be opened. In some embodiments, opening of a locked container may be detected, and an alert may be issued if a locked container is opened without corresponding identification.

In some embodiments, user identification data may be sent to a remote server, and the user identification data may be compared to reading of at least one unique readable tag to verify authorization of the user to access content. In some embodiments, the identification of a user may be received from a user interface unit. In some embodiments, a state of the lock unit may be changed from an unlocked state to a locked state.

In some embodiments, the container may be locked between the lock unit and a locking segment. In some embodiments, a portion of the locking segment may be wrapped around the container.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a block diagram of a container control system, according to some embodiments of the invention;

FIG. 2A schematically illustrates a perspective view of a lock unit assembled onto a container, according to some embodiments of the invention;

FIG. 2B schematically illustrates a perspective view of a key unit, according to some embodiments of the invention;

FIG. 2C schematically illustrates an exploded view of the lock unit and the container, according to some embodiments of the invention;

FIG. 2D schematically illustrates another perspective view of the key unit, according to some embodiments of the invention;

FIG. 2E schematically illustrates a perspective view of the container coupled to the key unit, according to some embodiments of the invention;

FIG. 2F schematically illustrates an exploded view of the container and the key unit, according to some embodiments of the invention;

FIG. 3 shows a flow chart of a method of controlling access to content of at least one container, according to some embodiments of the invention;

FIG. 4A schematically illustrates a perspective view of a petri dish container with a dedicated lock unit, according to some embodiments of the invention;

FIG. 4B schematically illustrates an exploded view of the petri dish container with the dedicated lock unit, according to some embodiments of the invention;

FIG. 4C schematically illustrates an exploded view of a perforated petri dish container with a dedicated lock unit, according to some embodiments of the invention;

FIG. 4D schematically illustrates an exploded view of a petri dish container with a dedicated housing lock unit, according to some embodiments of the invention;

FIG. 5A schematically illustrates an exploded view of a lock unit and a corresponding locking segment assembled onto a container, according to some embodiments of the invention;

FIG. 5B schematically illustrates a perspective view of a lock unit and a corresponding locking segment assembled onto a container, according to some embodiments of the invention; and

FIG. 6 schematically illustrates a lock unit assembled onto a perforated locking segment, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

It should be appreciated that as used hereinafter, the term ‘container’ may refer to at least one of boxes, jars, bottles, cans, beakers, test tubes, laboratory dishes such as petri dishes, laboratory vessels, straw covers, blood bags, semen vials, urine cups, Erlenmeyer flasks, and the like. For example, containers having direct contact with biological, chemical, or organic samples stored therein.

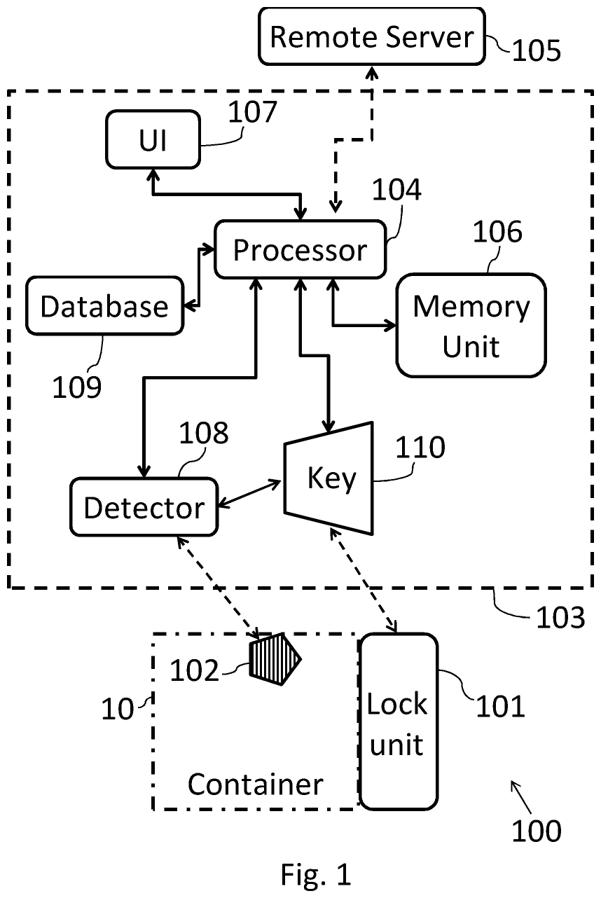

Reference is now made to FIG. 1, which schematically illustrates a block diagram of a container control system 100, according to some embodiments of the invention. System 100 may allow controlling access to content of at least one container 10. It should be noted that the direction of arrows in FIG. 1 may indicate the direction of information flow.

Container control system 100 may include a lock unit 101 configured to lock container 10 and prevent access to the content therein. In some embodiments, lock unit 101 may be coupled to container 10, and remain in contact while container 10 is in use (for instance remain fastened onto the container even when unlocked). In some embodiments, container 10 may be provided with a built-in lock unit 101 that may be initially locked to be unlocked with an external device. In some embodiments, lock unit 101 may be compatible with storage requirements of the respective container 10, for example lock unit 101 may be configured to withstand extreme temperature and/or pressure conditions (e.g., withstand low temperatures for vials with embryos).

According to some embodiments, at least one unique readable tag 102 may be attached to container 10 to be read by system 100, such that each container 10 may be uniquely identified by the respective readable tag 102. In some embodiments, the at least one unique readable tag 102 may be attached to built-in lock unit 101.

Container control system 100 may further include a key unit 103. In some embodiments, key unit 103 may include a processor 104, connectable to a remote external server 105 via a communication channel (e.g., via Wi-Fi connection). The processor 104 may be coupled to a memory unit 106, to store data therein, and/or processor 104 may be coupled to a user interface (UI) unit 107.

In some embodiments, memory unit 106 may store data that is indicative to each locked container 10, the stored data including information for at least one of content within the container 10, owner of the content within the container 10, and authorized users to open the container 10.

In some embodiments, key unit 103 may further include a detector 108, coupled to the processor 104, and adapted to read readable tags 102. In some embodiments, key unit 103 may further include a database 109, coupled to the processor 104, and including verification information for various containers 10. For example, database 109 may include information for details of the owner of content inside container 10, to be verified with identification of corresponding readable tag 102. In some embodiments, database 109 may include a list with authorized containers to be opened. In some embodiments, database 109 may store data locally (e.g., at an internal hospital server) without connection to an external network, for instance so only partial data may be sent externally to the owner and thereby prevent leakage of for example sensitive medical data. In some embodiments, database 109 may store data locally, for instance to prevent overloading the communication bandwidth, such that the external server may be updated during predetermined times (e.g., once an hour, every 24 hours, etc.). In some embodiments, in case of detecting extreme conditions (e.g., a fire, communication problems or power outage) database 109 may store data locally until return to normal operations and all data may then be transferred to the external server. In some embodiments, in case of extreme conditions a “master” key (e.g., used by a specific member of staff such as a lab manager) may be provided so as to open all types of containers without requirement to receive authorization from the external server or local/internal server.

Key unit 103 may further include a key 110, coupled to the detector 108 (e.g., via Wi-Fi connection), and adapted to unlock the lock unit 101 upon receipt of tag identification from the detector 108 and corresponding confirmation of the identified tag, as further described hereinafter. In some embodiments, receipt of tag identification may be carried out by processor 104.

In some embodiments, key 110 may be configured to lock an unlocked lock unit 101. In some embodiments, operation of key 110 to unlock and/or lock the lock unit 101 may be carried out mechanically and/or electronically.

In some embodiments, lock unit 101 may also be unlocked upon receipt of access authorization data, wherein the access authorization data may be provided by the remote server 105 upon confirmation of the tag identification data. In some embodiments, processor 104 may check compliance of the access authorization data to real-time conditions of handling the container 10 (e.g., check compliance with time stamp, identity of the user, lock/unlock action to be carried out, etc.). For example, detector 108 may read readable tag 102 and pass (e.g., via wireless communication) tag identification data to processor 104 to be confirmed by remote server 105 and thereby provide access authorization data. In some embodiments, user interface unit 107 may be configured to receive from server 105 the access authorization data for a locked container 10 identified by the detector 108.

In some embodiments, detector 108 may be configured to perform user identification for users using container control system 100. For example, detector 108 may identify a personnel identification tag (e.g., on the clothes of the user), and/or perform face recognition identification (e.g., with a dedicated camera), and/or identify a user via user interface unit 107 (e.g., with a password entered by the user).

In some embodiments, data stored on readable tags 102 may be rewritable (e.g., while the content is inserted into the container), for example in case the owner details for content within container 10 are modified. In some embodiments, each unique readable tag 102 may include access authorization data corresponding to owner of the content in the respective container 10. In some embodiments, each unique readable tag 102 may include access authorization data corresponding to the content in the respective container 10.

In some embodiments, key unit 103 may further include a communication module to allow communication between processor 104 and remote server 105, and/or allow communication between key 110 and lock unit 101. The communication module may allow wired and/or wireless communication. In some embodiments, such a communication module may further allow data transfer between other components of key unit 103, for example allowing data transfer between processor 104 and user interface 107.

In some embodiments, readable tags 102 may include radio-frequency identification (RFID), barcode identification, a quick response (QR) code, any other machine-readable identification, or a combination thereof.

According to some embodiments, the components of key unit 103 may be embedded into a single physical device (as further described hereinafter) while at least the key 110 may be external and coupled thereto, for example, with a dedicated cable.

According to some embodiments, a dedicated tracking algorithm may operate on remote server 105 to control permissions to lock and/or unlock containers. In some embodiments, such a dedicated tracking algorithm may allow owners of content within containers to track all process involving the content, for instance track opening of container to extract the content. In some embodiments, owners of content within containers may receive alerts for each action involving the container, for instance locking and/or unlocking of the container, disposal of the content, storage of the container, etc. In some embodiments, each or some action(s) may require a permission of the owner of the content within the container, for instance providing permission via a dedicated user interface via the remote server 105. In some embodiments, each or some action(s) may require a permission of a predefined user (e.g., a lab manager), for instance providing permission with a dedicated user interface via the remote server 105. In some embodiments, each or some action(s) may require a predefined feature, such as a geographic IP connection address, in order to identify a user accessing from an authorized network (e.g., located within a hospital).

For example, an owner of content within a container (e.g., a blood sample) may receive an indication that the content is to be examined by a user or staff member (e.g., a nurse) that scans a tag on the container with the details of the owner, such that opening of the container may be verified with the owner, and the results of the examination (e.g., blood test) may be accordingly sent to the owner.

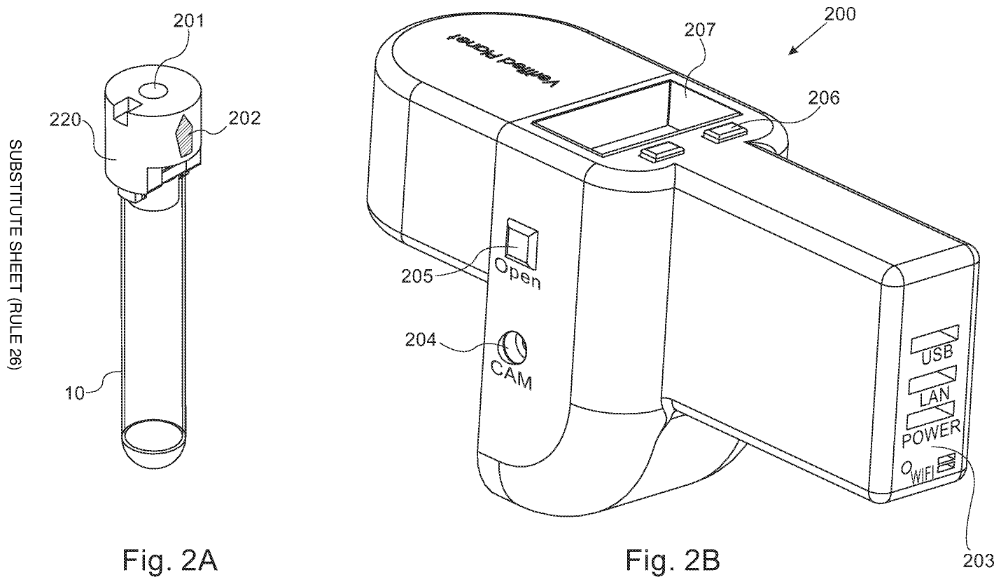

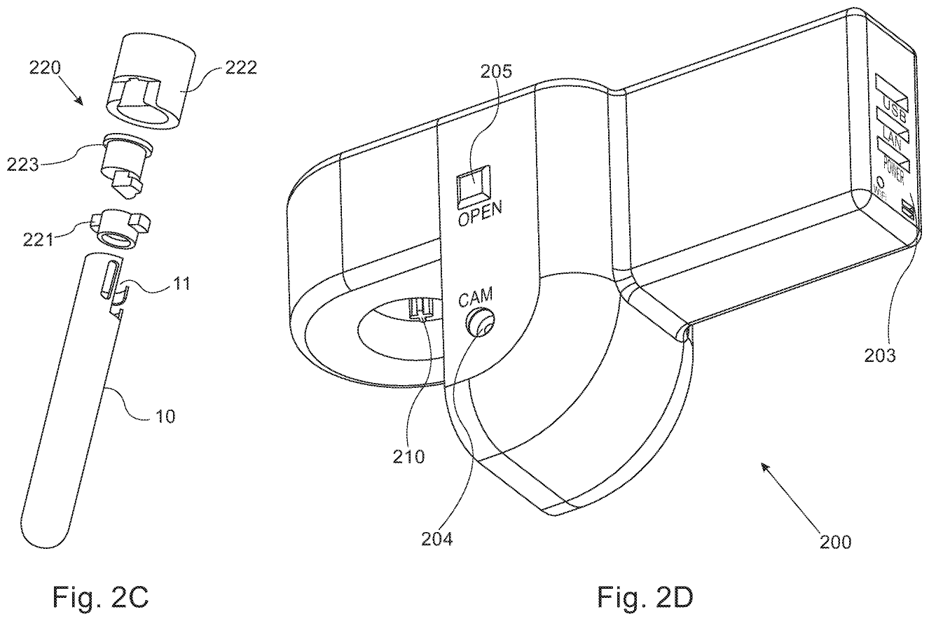

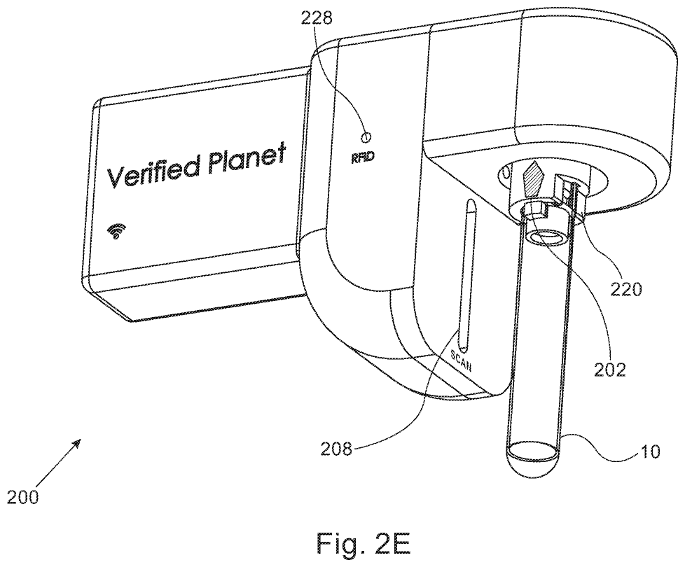

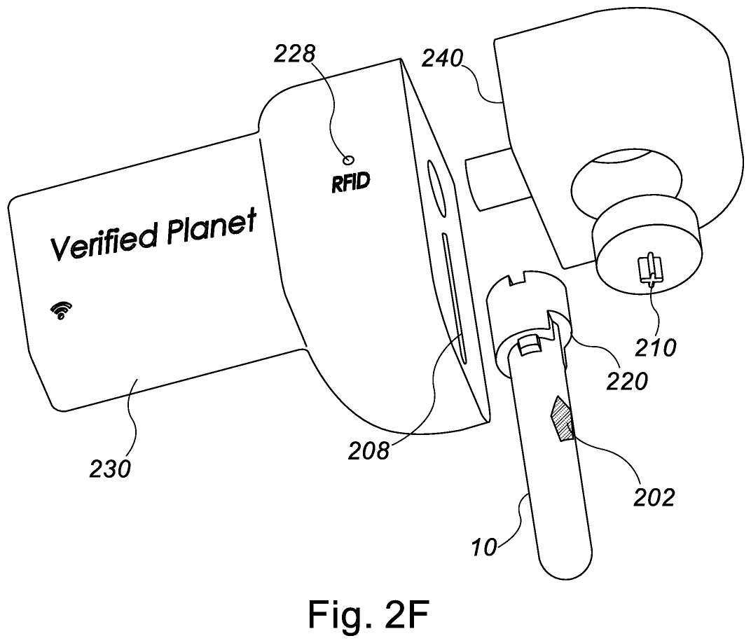

Reference is now made to FIGS. 2A-2F, which schematically illustrate a key unit 200 with a container 10, according to some embodiments of the invention. FIG. 2A schematically illustrates a perspective view of a lock unit 220 assembled onto a container 10, and FIG. 2B schematically illustrates a perspective view of a key unit 200.

According to some embodiments, lock unit 220 (e.g., similar to lock unit 101 shown in FIG. 1) may be assembled onto container 10, whereby lock unit 220 may have a cavity 201 for coupling with the key unit 200, as further described hereinafter. In some embodiments, containers 10 may be provided by the manufacturer with assembled lock unit 220 to be opened and/or closed by key unit 200.

In some embodiments, lock unit 220 may include at least one of the following locking elements: a cylinder lock, code operated lock, magnet lock, electrical lock, temperature sensitive lock (e.g., changing the properties of a portion of the lock by applying heat to allow access to the container), chemical lock (e.g., using a chemical reaction to change the properties of a portion of the lock to allow access to the container), and digital lock.

At least one unique readable tag 202 (e.g., similar to unique readable tag 102 shown in FIG. 1) may be attached to the body of container 10 (e.g., a food package at a factory) to be read by key unit 200. In some embodiments, at least one unique readable tag 202 may be embedded to lock unit 220.

Containers 10 with assembled lock unit 220 may be provided to staff members (e.g., to nurses at a medical clinic) in a locked state, to be registered with corresponding details of the respective container 10 and the owner of the content therein. In some embodiments, the registered details (e.g., registered via a user interface) may correspond to respective unique readable tag 202 and/or stored at a remote server.

According to some embodiments, key unit 200 may include a panel 203 with at least one of power input (e.g., for a battery or a cable), data cable input (e.g., for LAN communication), USB input, wireless communication module (e.g., via WiFi or GSM), a microphone and/or a speaker. In some embodiments, key unit 200 may utilize voice recognition (e.g., with microphone 203) to identify a user authorized to operate the key unit 200. In some embodiments, a microphone may detect alerts, and a speaker may issue voice messages to the user of the key unit 200. In some embodiments, an external thermometer may be coupled to key unit 200 via USB input 203, in order to allow temperature measurements (e.g., to verify appropriate temperature for the container).

In some embodiments, key unit 200 may further include a camera 204, for instance to scan a readable tag and/or to capture the face of a user (e.g., a nurse) in order to perform facial recognition so as to identify the correct user handling the container. In some embodiments, key unit 200 may include a biometric sensor (e.g., in panel 203) to utilize biometric identification, with camera 204 utilizing eye (e.g., iris) scanning and/or fingertip scanning and/or utilizing the microphone for voice recognition, to verify a user identification and authorization to handle container 10.

In some embodiments, key unit 200 may further include at least one release button 205 to allow a user to change the key unit 200 to engage a container 10 of a different type by releasing an interchangeable segment 240 as further described hereinafter and shown in FIG. 2F. In some embodiments, key unit 200 may further include at least one indicator 206 to indicate to a user a locked/unlocked state of a coupled container 10. In some embodiments, the opening of container 10 may be automatic (e.g., with electronic and/or mechanical means) upon receipt of corresponding authentication data.

In some embodiments, key unit 200 may further include a user interface 207 (e.g., similar to user interface 107 shown in FIG. 1) that may for instance allow a user to enter a password and thereby allow operation of key unit 200. For example, user interface 207 may be a touch screen presenting details and/or images of the owner of the content within the container 10.

FIG. 2C schematically illustrates an exploded view of lock unit 220 and container 10 according to an embodiment of the present invention, and FIG. 2D schematically illustrates another perspective view of key unit 200 according to embodiments of the present invention.

According to some embodiments, lock unit 220 may include a first portion 221 configured to cover an opening 11 of container 10, and a second portion 222 configured to cover the first portion 221. In some embodiments, first portion 221 may be at least partially sterilized prior to coupling with container 10. In some embodiments, second portion 222 may have a cavity 201 (shown in FIG. 2A) for coupling with key segment 210 (e g , similar to key 110 shown in FIG. 1) of the key unit 200.

According to some embodiments, lock unit 220 may further include a third portion 223 to be placed between first portion 221 and second portion 222 so as to provide additional protection to lock unit 220. In some embodiments, first portion 221, second portion 222 and third portion 223 may be assembled onto a container 10 prior to handling by the user of the container control system. In some embodiments, at least one unique readable tag 202 (e.g., as shown in FIG. 2A) may be embedded within third portion 223. In some embodiments, to unlock lock unit 220, key segment 210 (shown in FIG. 2D) may engage and mechanically and/or electrically, change a position (e.g., rotate, slide, push, pull etc.) of third portion 223 with respect to second portion 222, and as a result disengage second portion 222 from third portion 223 (and first portion 221), then container 10 may be opened, e.g., by moving or removing second portion 222 and manually remove third portion 223 and first portion 221 from opening 11 of container 10 and thereby allow access to the content therein. In some embodiments, second portion 222 may be pivotally coupled to container 10.

According to some embodiments, the user may couple (or engage) the cavity 201 of second portion 222 with key segment 210 of the key unit 200 in order to commence locking and/or unlocking of container 10. For example, a user may engage lock unit 220 with key unit 200, by coupling (or inserting) the key segment 210 with the cavity 201 such that at least one unique readable tag 202 of container 10 may be read by key unit 200.

FIG. 2E schematically illustrates a perspective view of container 10 coupled to key unit 200. After container 10 is coupled to key unit 200, at least one unique readable tag 202 (e.g., attached to container 10) may be read by detector 208 (e.g., similar to detector 108 shown in FIG. 1) of the key unit 200. For example, a barcode (or RFID) readable tag 202 may be attached to container 10 to be read by detector 208 and/or scanned by camera 204. In some embodiments, key unit 200 may further include a second tag scanner 228 configured to read additional readable tags, for instance scan RFID tag worn by a lab staff member to identify a user authorized to operate key unit 200.

For example, the user may couple lock unit 220 of a locked container 10 to key segment 210 of key unit 200. The key unit 200 may scan (e.g., with detector 208) the readable tag 202 of container 10 to identify the container 10. Upon identification of the container 10, key unit 200 may receive access authorization data (e.g., from a remote server and/or a local computing system or server) to allow locking/unlocking of container 10.

In some embodiments, key unit 200 may receive access authorization data from a computerized device in communication with a remote server coupled to key unit 200. For example, owner of content within the container may provide access authorization data via at least one of a smartphone, tablet, PC (with compatible software), a wearable device (e.g., a dedicated bracelet) or any other computerized device capable of allowing the owner to track and/or control the content within the container.

FIG. 2F schematically illustrates an exploded view of container 10 and key unit 200. According to some embodiments, key unit 200 may include a first segment 230 and a second interchangeable segment 240 configured to be assembled to form the key unit 200.

In some embodiments, second interchangeable segment 240 may include key segment 210 for a particular type of lock unit 220. In order to lock/unlock a different type of container 10 (or different lock unit 220), it may be possible to change key segment 210 and/or entire second interchangeable segment 240. As may be apparent to one of ordinary skill in the art, the user may use the same first segment 230 (e.g., having a gripping portion to be held by the user) while different second interchangeable segments 240 and/or different key segments 210 may correspond to different types of lock units 220. In some embodiments, a single (or universal) second interchangeable segment 240 may be able to operate with all types of containers 10 (or lock units 220).

In some embodiments, additional predefined settings may be required for authorization to open a closed container 10. For example, blood test are usually carried out during standard working hours, so that accessing the containers 10 outside of the standard working hours (e.g., predefined working hours) may not be allowed. In some embodiments, authorization to open a closed container 10 may be provided only during presence of a predefined staff member (e.g., head nurse). In some embodiments, various actions in handling the containers 10 may require different authorization, for example handling blood test may require specific user ID (e.g., head nurse) during sample collection and/or require ID of at least two staff members.

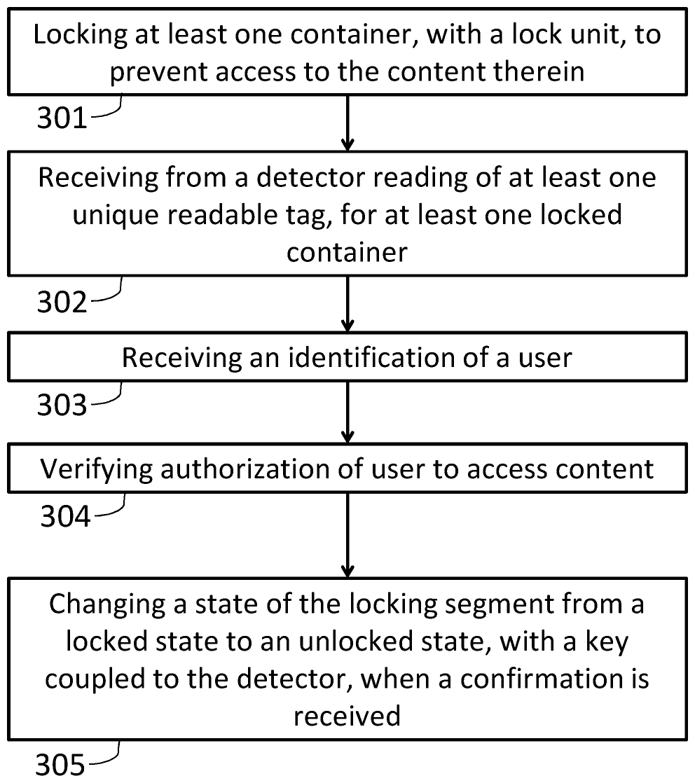

Reference is now made to FIG. 3, which schematically illustrates a flow chart of a method of controlling access to content of at least one container, according to some embodiments of the invention. In some embodiments, the method may include locking 301 at least one container 10, with a lock unit 101, to prevent access to the content therein.

In some embodiments, the method may further include receiving 302 from a detector 108 reading of at least one unique readable tag 102, for at least one locked container 10. In some embodiments, the method may further include receiving 303 an identification of a user.

In some embodiments, the method may further include verifying 304 authorization of user to access content, and changing 305 a state of the lock unit 101 from a locked state to an unlocked state, with a key 110 coupled to the detector 108, when a confirmation is received. In some embodiments, the identification of a user may be received from a user interface unit 107. For example, verifying 304 authorization of the user to access content within the container 10 may include (e.g., prior to opening the container) checking what is the purpose of the required action, for instance for fertilization of biological material in a first container with material in a second container. Thus, the user (e.g., a lab staff member) may initially scan the tags of first and second containers to verify correct containers 10 and correct owners of content therein, and may then check permission to handle these containers 10 and carry out the necessary action involving both containers 10.

In some embodiments, the method may further include attaching a unique readable tag 102 to each of the at least one locked container. In some embodiments, the method may further include comparing tag identification to a database of authorized containers to be opened. In some embodiments, the method may further include detecting opening of a locked container 10, and issuing an alert if a locked container 10 is opened without corresponding identification. In some embodiments, the method may further include changing a state of the lock unit 101 from an unlocked state to a locked state.

In some embodiments, the method may further include sending user identification data to a remote server 105, and comparing user identification data to reading of at least one unique readable tag 102 to verify authorization of the user to access content.

In some embodiments, an owner of content to be deposited in a container (e.g., semen sample) may identify the container (e.g., a tube), and sign and/or provide a predefined code (e.g., in the UI) to confirm locking of the container. Thus, the owner may approve his/hers identity on the corresponding container. In some embodiments, the owner may scan a personal magnetic card (e.g., medical card with a dedicated tag) to approve the sampling into and closing of the container with the content therein.

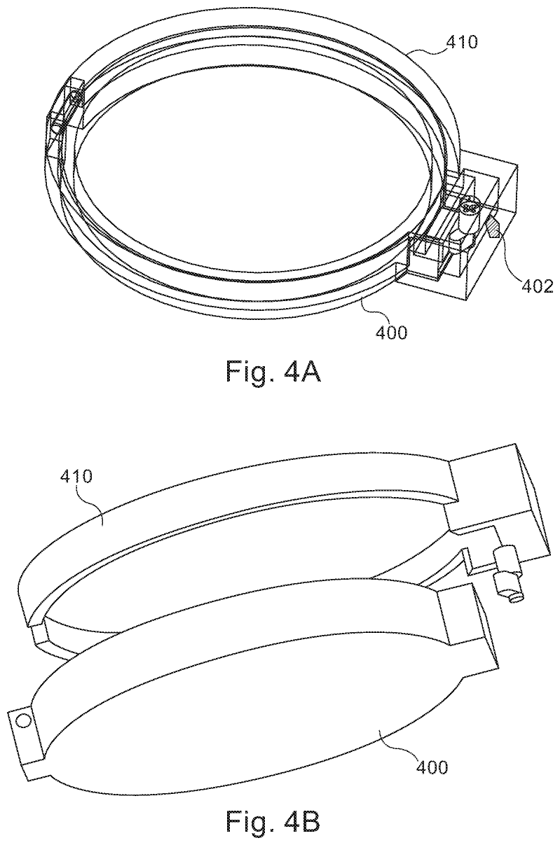

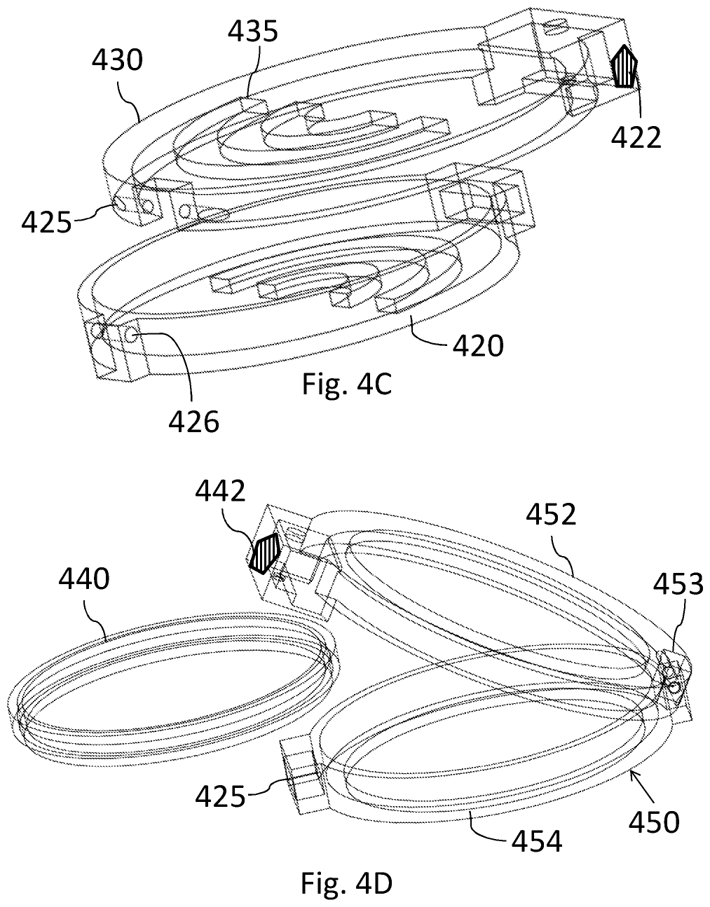

Reference is now made to FIGS. 4A-4B, which schematically illustrate a perspective and exploded view, respectively, of a petri dish container 400 with a dedicated lock unit 410 and a corresponding unique readable tag 402, according to some embodiments of the invention. It should be appreciated that a dedicated lock unit may be fitted to different types of containers (e.g., a straw containing human eggs for fertilization), to comply with the abovementioned method and system for controlling access to content of containers.

Reference is now made to FIG. 4C, which schematically illustrates an exploded view of a perforated petri dish container 420 with a dedicated lock unit 430 and a corresponding unique readable tag 422 (e.g., on the lock unit 430), according to some embodiments of the invention. The perforated petri dish container 420 may have, in some embodiments, similar structural elements as in petri dish container 400 (shown in FIGS. 4A-4B) while at least one of the perforated petri dish container 420 and the dedicated lock unit 430 may be perforated, for instance in order to reduce mass and/or material of the container. In some embodiments, lock unit 430 may also be perforated.

The lock unit 430 may allow locking of the petri from the outside, for instance with a locking element (e.g., a pin) inserted into a dedicated cavity 425 in the lock unit 430 and also into a corresponding cavity 426 in the perforated petri dish container 420. In some embodiments, once the lock unit 430 is attached and/or locked to the container (e.g., the petri dish container 420) the lock unit 430 may not be removed unless an external key is used to open the lock unit 430 in order to give access to the content of the container.

Reference is now made to FIG. 4D, which schematically illustrates an exploded view of a petri dish container 440 with a dedicated housing lock unit 450 and a corresponding unique readable tag 442 on the housing lock unit 450, according to some embodiments of the invention.

The housing lock unit 450 may include a top portion 452 and a bottom portion 454, for instance having a common pivot element 453. In some embodiments, the petri dish container 440 may be housed within the housing lock unit 450 and locked with the locking element 425 (e.g., with insertion of a pin in a dedicated cavity). In some embodiments, once the housing lock unit 450 is attached and/or locked to the petri dish container 440 the housing lock unit 450 may not be removed unless an external key is used to open the lock unit 450 in order to give access to the content of the container.

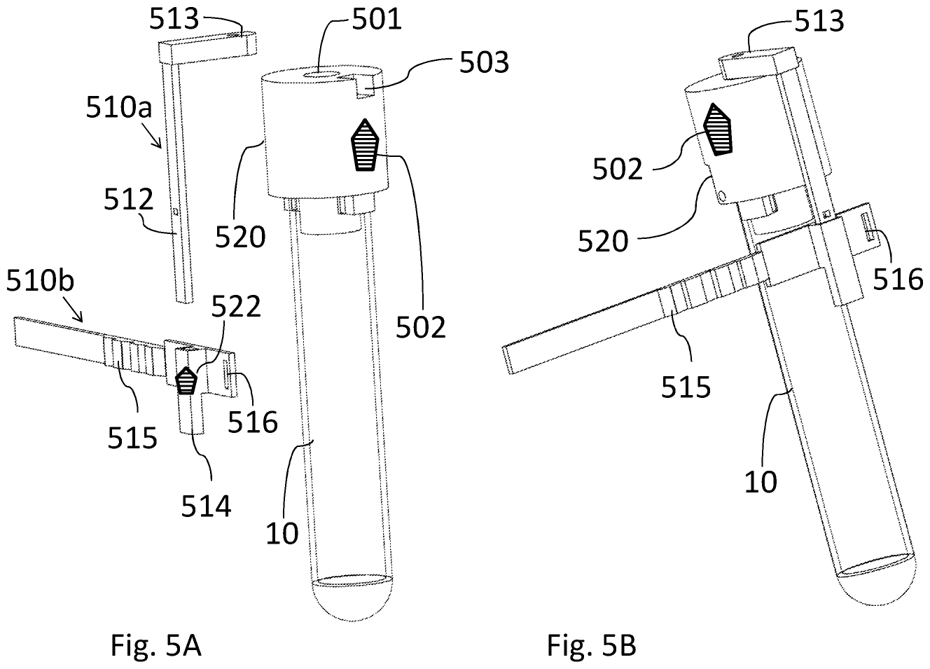

Reference is now made to FIGS. 5A-5B, which schematically illustrate an exploded and perspective view, respectively, of a lock unit 520 and a corresponding locking segment 510 assembled onto a container 10, according to some embodiments of the invention. In some embodiments, lock unit 520 (e g., similar to lock unit 220 shown in FIG. 2A) may be assembled onto container 10, whereby lock unit 520 may have a cavity 501 for coupling with the key unit (such as key unit 200 shown in FIG. 2E).

In some embodiments, containers 10 may be provided by the manufacturer with assembled lock unit 520 to be opened and/or closed by the key unit upon validation of the unique readable tag 502. The locking segment 510 may include a top segment 510a and a bottom segment 510b to be assembled together into locking segment 510 and configured to couple to lock unit 520, as further described hereinafter. In some embodiments, at least one unique readable tag 522 may be embedded into locking segment 510, in addition to or instead of the unique readable tag 502, thereby insuring proper identification of the container 10.

The top segment 510a may include a protruding tip 513 for coupling (e.g., using a snap) with a compatible socket 503 in the lock unit 520 so as to cover the cavity 501, and a longitudinal portion 512 (e.g., perpendicular to the protruding tip 513). The bottom segment 510b may include a hollow portion 514 configured to at least partially accommodate the longitudinal portion 512 of the top segment 510a. In some embodiments, a user may position the bottom segment 510b along the container such that the longitudinal portion 512 may be at least partially accommodated within the hollow portion 514 and thereby modify the structure of the locking segment 510 in accordance with the size of container 10 (e.g., the height), for instance by sliding the longitudinal portion 512 through the hollow portion 514.

The bottom segment 510b may also include a wrapping portion 515 (e.g., a cable tie) configured to be wrapped around the container 10 and inserted into compatible window 516. In some embodiments, a user may wrap the bottom segment 510b around the container such that the wrapping portion 515 may wrap container 10 and thereby modify the structure of the locking segment 510 in accordance with the size of container 10 (e.g., the width), for instance by locking the wrapping portion 515 at window 516. It should be noted that using such structure of locking segment 510, once the container 10 is locked it is no longer possible to mechanically separate container 10 from the lock unit 520 and such locking segment 510 may be adapted to various shapes and/or sizes of containers 10.

In order to gain access to the content of container 10, the unique readable tag (e.g., tag 502 and/or tag 522) may be identified and validated by the key unit as described above, such that coupling of the key unit with the lock unit 520 may release the lock and provide access to the sterilized portion of container 10.

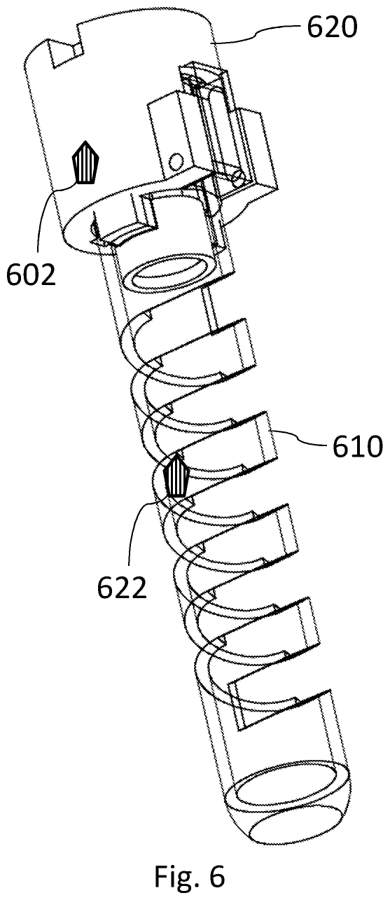

Reference is now made to FIG. 6, which schematically illustrates a lock unit 620 assembled onto a perforated locking segment 610, according to some embodiments of the invention. The lock unit 620 (e.g., similar to lock unit 220 shown in FIG. 2A) may be assembled with perforated locking segment 610 (e.g., having a spiral shape and perforated in order to reduce mass and/or material of locking segment 610) onto the container. In some embodiments, the unique readable tag 502 may be embedded into the lock unit 620. In some embodiments, the perforated locking segment 610 may be at least partially transparent in order to allow viewing of the container therein.

In some embodiments, the container may initially be inserted into the perforated locking segment 610 such that the lock unit 620 may be coupled onto perforated locking segment 610 and thereby lock the container therein. In some embodiments, at least one unique readable tag 622 may be embedded into locking segment 610, in addition to or instead of the unique readable tag 602, thereby insuring proper identification of the container. It should be noted that locking segment 610 may therefore prevent unwanted handling of the container (e.g., mechanical removal of the container) without the external key unit.

Unless explicitly stated, the method embodiments described herein are not constrained to a particular order in time or chronological sequence. Additionally, some of the described method elements can be skipped, or they can be repeated, during a sequence of operations of a method.

Various embodiments have been presented. Each of these embodiments may of course include features from other embodiments presented, and embodiments not specifically described may include various features described herein.

1. A system for controlling access to content of at least one container, wherein the system is remotely connected to an external server, the system comprising:
a lock unit, configured to lock a container and prevent access to the content therein;
a unique readable tag, attachable to the container; and
a key unit, wherein the key unit comprises:
a processor, connectable to the server via a communication channel;
a detector, coupled to the processor, and adapted to read readable tags; and
a key, coupled to the detector, and adapted to unlock the lock unit upon receipt, by the processor, of tag identification from the detector and also receipt of access authorization data,
wherein the access authorization data is provided by the server upon confirmation of the tag identification data.

2. The system of claim 1, wherein the key unit further comprises a user interface unit to receive from the server the access authorization data for a locked container identified by the detector.

3. The system of claim 1, further comprising a memory unit, coupled to the processor, to store data that is indicative to each locked container, wherein the stored data comprises information for at least one of content within the container, owner of the content within the container, and authorized users to open the container.

4. The system of claim 1, wherein the unique readable tag comprises radio-frequency identification (RFID).

5. The system of claim 1, wherein each unique readable tag comprises access authorization data corresponding to owner of the content in the respective container.

6. The system of claim 1, wherein each unique readable tag comprises access authorization data corresponding to the content in the respective container.

7. The system of claim 1, wherein the detector is further configured to perform user identification.

8. The system of claim 1, further comprising a database, coupled to the server, the database comprising a list with authorized containers to be opened.

9. The system of claim 1, wherein the key is further configured to lock the container.

10. The system of claim 1, further comprising a locking segment configured to be assembled onto the container and also configured to be coupled to the lock unit.

11. The system of claim 10, wherein the locking segment comprises a wrapping portion configured to be wrapped around the container.

12. A method of controlling access to content of at least one container, the method comprising:
locking at least one container, with a lock unit, to prevent access to the content therein;
receiving from a detector reading of at least one unique readable tag, for at least one locked container;
receiving an identification of a user;
verifying authorization of user to access content; and
changing a state of the lock unit from a locked state to an unlocked state, with a key coupled to the detector, when a confirmation is received.

13. The method of claim 12, further comprising attaching a unique readable tag to each of the at least one locked container.

14. The method of claim 12, further comprising comparing tag identification to a database of authorized containers to be opened.

15. The method of claim 12, further comprising:
detecting opening of a locked container; and
issuing an alert if a locked container is opened without corresponding identification.

16. The method of claim 12, further comprising:
sending user identification data to a remote server; and
comparing user identification data to reading of at least one unique readable tag to verify authorization of the user to access content.

17. The method of claim 12, wherein the identification of a user is received from a user interface unit.

18. The method of claim 12, further comprising changing a state of the lock unit from an unlocked state to a locked state.

19. The method of claim 12, further comprising locking the container between the lock unit and a locking segment.

20. The method of claim 19, further comprising wrapping a portion of the locking segment around the container.
